(19) United States
(12) Patent Application Publication
(10) Pub. No.: US 2004/0030799 A1
(43) Pub. Date: Feb. 12, 2004

(54) Bandwidth allocation fairness within a processing system of a plurality of processing devices

(76) Inventor: Manu Gulati, Santa Clara, CA (US)

Correspondence Address: GARLICK HARRISON & MARKISON LLP, P.O. BOX 160727, AUSTIN, TX, 78716-0727, US

(21) Appl. No.: 10/356,346

(22) Filed: Jan. 31, 2003

Related U.S. Application Data
(60) Provisional application No. 60/380,740, filed on May 15, 2002.
(60) Provisional application No. 60/419,043, filed on Oct. 16, 2002.

(51) Int. Cl. G06F 15/16

(52) U.S. Cl. 709/233

(57) ABSTRACT

In a processing system, when a processing device of the processing system is configured to transceive packets in a bridge mode, the processing device inserts packets into upstream packet traffic (i.e., traffic destined for the host) in accordance with a 1^{st} bandwidth allocation policy. When the processing device is configured in a tunnel-bridge hybrid mode, the processing device determines upstream loading from downstream processing devices. The processing device then inserts packets into the upstream packet traffic in accordance with a 2^{nd} bandwidth allocation policy based on the upstream loading.

The present application claims priority under 35 U.S.C. 119(e) to the following applications, each of which is incorporated herein for all purposes:

(1) provisional patent application entitled SYSTEM ON A CHIP FOR NETWORKING, having an application number of Ser. No. 60/380,740, and a filing date of May 15, 2002; and

(2) provisional patent application having the same title as above, having an application number of Ser. No. 60/419,043, and a filing date of Oct. 16, 2002.

### BACKGROUND OF THE INVENTION

1. Technical Field of the Invention

The present invention relates generally to data communications and more particularly to high-speed wired data communications.

2. Description of Related Art

As is known, communication technologies that link electronic devices are many and varied, servicing communications via both physical media and wirelessly. Some communication technologies interface a pair of devices, other communication technologies interface small groups of devices, and still other communication technologies interface large groups of devices.

Examples of communication technologies that couple small groups of devices include buses within digital computers, e.g., PCI (peripheral component interface) bus, ISA (industry standard architecture) bus, an USB (universal serial bus), SPI (system packet interface) among others. One relatively new communication technology for coupling relatively small groups of devices is the HyperTransport (HT) technology, previously known as the Lightning Data Transport (LDT) technology (HyperTransport I/O Link Specification “HT Standard”). The HT Standard sets forth definitions for a high-speed, low-latency protocol that can interface with today's buses like AGP, PCI, SPI, 1394, USB 2.0, and 1 Gbit Ethernet as well as next generation buses including AGP 8×, Infiniband, PCI-X, PCI 3.0, and 10 Gbit Ethernet. HT interconnects provide high-speed data links between coupled devices. Most HT enabled devices include at least a pair of HT ports so that HT enabled devices may be daisy-chained. In an HT chain or fabric, each coupled device may communicate with each other coupled device using appropriate addressing and control. Examples of devices that may be HT chained include packet data routers, server computers, data storage devices, and other computer peripheral devices, among others.

Of these devices that may be HT chained together, many require significant processing capability and significant memory capacity. Thus, these devices typically include multiple processors and have a large amount of memory. While a device or group of devices having a large amount of memory and significant processing resources may be capable of performing a large number of tasks, significant operational difficulties exist in coordinating the operation of multiple processors. While each processor may be capable of executing a large number operations in a given time period, the operation of the processors must be coordinated and memory must be managed to assure coherency of cached copies. In a typical multi-processor installation, each processor typically includes a Level 1 (L1) cache coupled to a group of processors via a processor bus. The processor bus is most likely contained upon a printed circuit board. A Level 2 (L2) cache and a memory controller (that also couples to memory) also typically couples to the processor bus. Thus, each of the processors has access to the shared L2 cache and the memory controller and can snoop the processor bus for its cache coherency purposes. This multi-processor installation (node) is generally accepted and functions well in many environments.

However, network switches and web servers often times require more processing and storage capacity than can be provided by a single small group of processors sharing a processor bus. Thus, in some installations, a plurality processor/memory groups (nodes) is sometimes contained in a single device. In these instances, the nodes may be rack mounted and may be coupled via a back plane of the rack. Unfortunately, while the sharing of memory by processors within a single node is a fairly straightforward task, the sharing of memory between nodes is a daunting task. Memory accesses between nodes are slow and severely degrade the performance of the installation. Many other shortcomings in the operation of multiple node systems also exist. These shortcomings relate to cache coherency operations, interrupt service operations, etc.

While HT links provide high-speed connectivity for the above-mentioned devices and in other applications, they are inherently inefficient in some ways. For example, in a “legal” HT chain, one HT enabled device serves as a host bridge while other HT enabled devices serve as dual link tunnels and a single HT enabled device sits at the end of the HT chain and serves as an end-of-chain device (also referred to as an HT “cave”). According to the HT Standard, all communications must flow through the host bridge, even if the communication is between two adjacent devices in the HT chain. Thus, if an end-of-chain HT device desires to communicate with an adjacent HT tunnel, its transmitted communications flow first upstream to the host bridge and then flow downstream from the host bridge to the adjacent destination device. Such communication routing, while allowing the HT chain to be well managed, reduces the overall throughput achievable by the HT chain, increases latency of operations, and reduces concurrency of transactions.

Applications, including the above-mentioned devices, that otherwise benefit from the speed advantages of the HT chain are hampered by the inherent delays and transaction routing limitations of current HT chain operations. Because all transactions are serviced by the host bridge and the host a limited number of transactions it can process at a given time, transaction latency is a significant issue for devices on the HT chain, particularly so for those devices residing at the far end of the HT chain, i.e., at or near the end-of-chain device. Further, because all communications serviced by the HT chain, both upstream and downstream, must share the bandwidth provided by the HT chain, the HT chain may have insufficient total capacity to simultaneously service all required transactions at their required bandwidth(s). Moreover, a limited number of transactions may be addressed at any time by any one device such as the host, e.g., 32 transactions (2**5). The host bridge is therefore limited in the number of transactions that it may have outstanding at any time and the host bridge may be unable to service all required transactions satisfactorily. Each of these operational limitations affects the ability of an HT chain to service the communications requirements of coupled devices.

Further, even if an HT enabled device were incorporated into a system (e.g., an HT enabled server, router, etc. were incorporated into an circuit-switched system or packet-switched system), it would be required to interface with a legacy device that uses an older communication protocol. For example, if a line card were developed with HT ports, the line card would need to communicate with legacy line cards that include SPI ports.

Therefore, a need exists for methods and/or apparatuses for interfacing devices using one or more communication protocols in one or more configurations while overcoming the bandwidth limitations, latency limitations, limited concurrency, and other limitations associated with the use of a high-speed HT chain.

### BRIEF SUMMARY OF THE INVENTION

The bandwidth allocation fairness within a processing system that includes processing devices in accordance with the present invention substantially meets these needs and others. In an embodiment, when a processing device is configured to transceive packets in a bridge mode, the processing device inserts packets into upstream packet traffic (i.e., traffic destined for the host) in accordance with a 1^{st} bandwidth allocation policy. When the processing device is configured in a tunnel-bridge hybrid mode, the processing device determines upstream loading from downstream processing devices. The processing device then inserts packets into the upstream packet traffic in accordance with a 2^{nd} bandwidth allocation policy, which may be fair or unfair with respect to bandwidth allocation, based on the upstream loading. Accordingly, based on the configuration of the processing device, the processing device overcomes bandwidth limitations, latency limitations and/or other limitations associated with the use of high speed HyperTransport chains.

### BRIEF DESCRIPTION OF THE SEVERAL VIEWS OF THE DRAWINGS

FIG. 1 is a schematic block diagram of a processing system in accordance with the present invention;

FIG. 2 is a schematic block diagram of an alternate processing system in accordance with the present invention;

FIG. 3 is a schematic block diagram of another processing system in accordance with the present invention;

FIG. 4 is a schematic block diagram of a multiple processor device in accordance with the present invention;

FIG. 5 is a graphical representation of transporting data between devices in accordance with the present invention;

FIG. 6 is a logic diagram of a method for providing bandwidth allocation fairness within a processing system in accordance with the present invention;

FIG. 7 is a graphical example of a 1^{st} bandwidth allocation policy in accordance with the present invention; and

FIGS. 8 and 9 are a graphical example of variations of a 2^{nd} bandwidth allocation policy in accordance with the present invention.

### DETAILED DESCRIPTION OF THE INVENTION

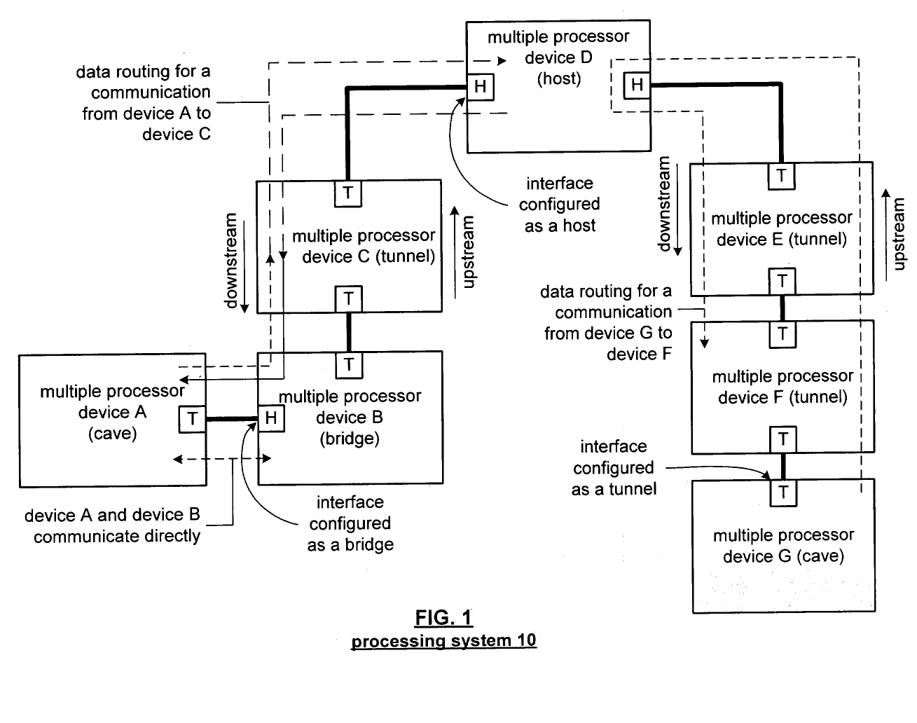

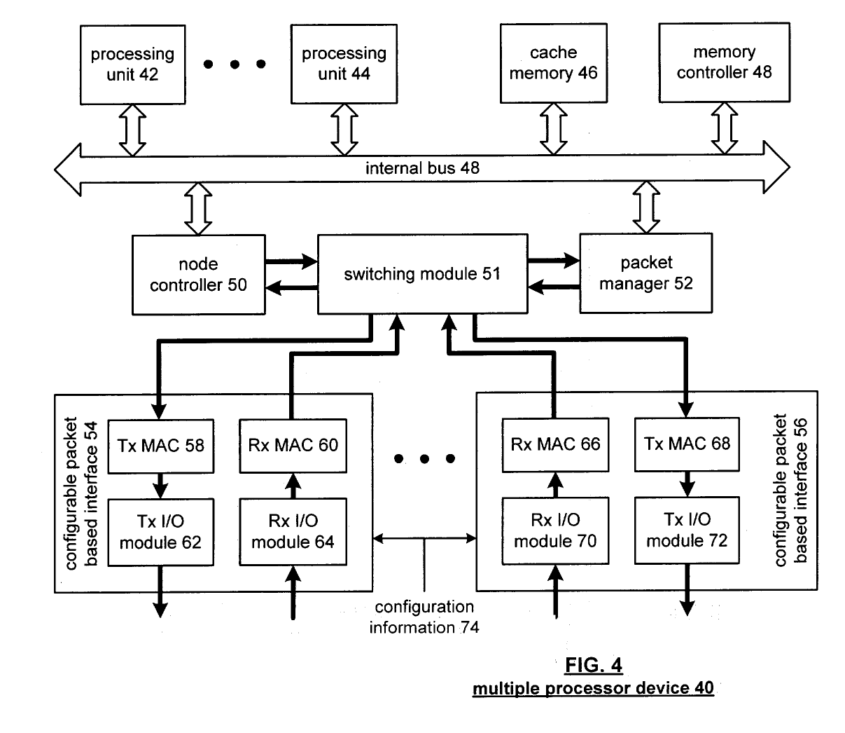

FIG. 1 is a schematic block diagram of a processing system 10 that includes a plurality of multiple processor devices A-G. Each of the multiple processor devices A-G include at least two interfaces, which, in this illustration, are labeled as T for tunnel functionality or H for host or bridge functionality. The details of the multiple processor devices A-G will be described in greater detail with reference to FIG. 4.

In this example of a processing system 10, multiple processor device D is functioning as a host to support two primary chains. The 1^{st} primary chain includes multiple processor device C, which is configured to provide a tunnel function, and multiple processor device B, which is configured to provide a bridge function. The other primary chain supported by device D includes multiple processor devices E and F, which are each configured to provide tunneling functionality, and multiple processor device G, which is configured to provide a cave function. The processing system 10 also includes a secondary chain that includes multiple processor devices A and B, where device A is configured to provide a cave function. Multiple processor device B functions as the host for the secondary chain. By convention, data from the devices (i.e., nodes) in a chain to the host device is referred to as upstream data and data from the host device to the node devices is referred to as downstream data.

In general, when a multiple processor device is providing a tunneling function, it passes, without interpretation, all packets received from downstream devices (i.e., the multiple processor devices that, in the chain, are further away from the host device) to the next upstream device (i.e., an adjacent multiple processor device that, in the chain, is closer to the host device). For example, multiple processor device E provides all upstream packets received from downstream multiple processor devices F and G to host device D without interpretation, even if the packets are addressing multiple processor device E. The host device D modifies the upstream packets to identify itself as the source of packets and sends the modified packets downstream along with any packets that it generated. As the multiple processor devices receive the downstream packets, they interpret the packet to identify the host device as the source and to identify a destination. If the multiple processor device is not the destination, it passes the downstream packets to the next downstream node. For example, packets received from the host device D that are directed to the multiple processor device E will be processed by the multiple processor device E, but device E will pass packets for devices F and G. The processing of packets by device E includes routing the packets to a particular processing unit within device E, routing to local memory, routing to external memory associated with device E, et cetera.

In this configuration, if multiple processor device G desires to send packets to multiple processor device F, the packets would traverse through devices E and F to host device D. Host device D modifies the packets identifying the multiple processor device D as the source of the packets and provides the modified packets to multiple processor device E, which would in turn forward them to multiple processor device F. A similar type of packet flow occurs for multiple processor device B communicating with multiple processor device C, for communications between devices G and E, and for communications between devices E and F.

For the secondary chain, devices A and B can communication directly, i.e., they support peer-to-peer communications therebetween. In this instance, the multiple processor device B has one of its interfaces (H) configured to provide a bridge function. Accordingly, the bridge functioning interface of device B interprets packets it receives from device A to determine the destination of the packet. If the destination is local to device B (i.e., meaning the destination of the packet is one of the modules within multiple processor device B or associated with multiple processor device B), the H interface processes the received packet. The processing includes forwarding the packet to the appropriate destination within, or associated with, device B.

If the packet is not destined for a module within device B, multiple processor device B modifies the packet to identify itself as the source of the packets. The modified packets are then forwarded to the host device D via device C, which is providing a tunneling function. For example, if device A desires to communicate with device C, device A provides packets to device B and device B modifies the packets to identify itself as the source of the packets. Device B then provides the modified packets to host device D via device C. Host device D then, in turn, modifies the packets to identify itself as the source of the packets and provides the again modified packets to device C, where the packets are subsequently processed. Conversely, if device C were to transmit packets to device A, the packets would first be sent to host D, modified by device D, and the modified packets would be provided back to device C. Device C, in accordance with the tunneling function, passes the packets to device B. Device B interprets the packets, identifies device A as the destination, and modifies the packets to identify device B as the source. Device B then provides the modified packets to device A for processing thereby.

In the processing system 10, device D, as the host, assigns a node ID (identification code) to each of the other multiple processor devices in the system. Multiple processor device D then maps the node ID to a unit ID for each device in the system, including its own node ID to its own unit ID. Accordingly, by including a bridging functionality in device B, in accordance with the present invention, the processing system 10 allows for interfacing between devices using one or more communication protocols and may be configured in one or more configurations while overcoming bandwidth limitations, latency limitations and other limitations associated with the use of high speed HyperTransport chains. Such communication protocols include, but are not limited to, a HyperTransport protocol, system packet interface (SPI) protocol and/or other types of packet-switched or circuit-switched protocols.

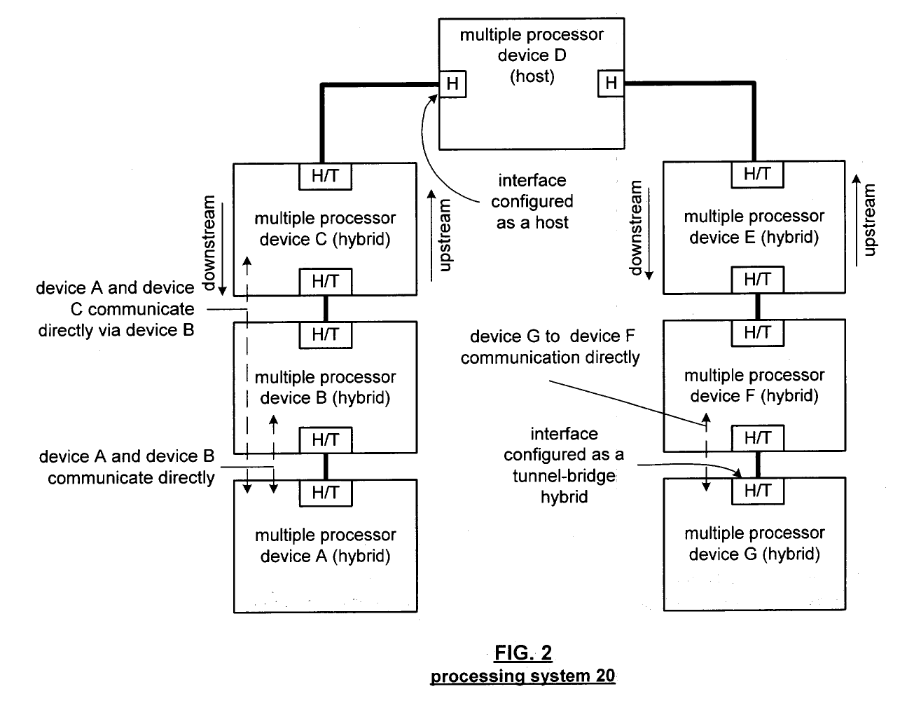

FIG. 2 is a schematic block diagram of an alternate processing system 20 that includes a plurality of multiple processor devices A-G. In this system 20, multiple processor device D is the host device while the remaining devices are configured to support a tunnel-bridge hybrid interfacing functionality. Each of multiple processor devices A-C and E-G have their interfaces configured to support the tunnel-bridge hybrid (H/T) mode. With the interfacing configured in this manner, peer-to-peer communications may occur between multiple processor devices in a chain. For example, multiple processor device A may communicate directly with multiple processor device B and may communicate with multiple processor device C, via device B, without routing packets through the host device D. For peer-to-peer communication between devices A and B, multiple processor device B interprets the packets received from multiple processor device A to determine whether the destination of the packet is local to multiple processor device B. With reference to FIG. 4, a destination associated with multiple processor device B may be any one of the plurality of processing units 42-44, cache memory 46 or system memory accessible through the memory controller 48. Returning back to the diagram of FIG. 2, if the packets received from device A are destined for a module within device B, device B processes the packets by forwarding them to the appropriate module within device B. If the packets are not destined for device B, device B forwards them, without modifying the source of the packets, to multiple processor device C. As such, for this example, the source of packets remains device A.

The packets received by multiple processor device C are interpreted to determine whether a module within multiple processor device C is the destination of the packets. If so, device C processes them by forwarding the packets to the appropriate module within, or associated with, device C. If the packets are not destined for a module within device C, device C forwards them to the multiple processor device D. Device D modifies the packets to identify itself as the source of the packets and provides the modified packets to the chain including devices E-G. Note that device C, having interpreted the packets, passes only packets that are destined for a device other than itself in the upstream direction. Since device D is the only upstream device for the primary chain that includes device C, device D knows, based on the destination address, that the packets are for a device in the other primary chain.

Devices E-G, in order, interpret the modified packets to determine whether it is a destination of the modified packets. If so, the device processes the packets. If not, the device routes the packets to the next device in chain. In addition, devices E-G support peer-to-peer communications in a similar manner as devices A-C. Accordingly, by configuring the interfaces of the devices to support a tunnel-bridge hybrid function, the source of the packets is not modified (except when the communications are between primary chains of the system), which enables the devices to use one or more communication protocols (e.g., HyperTransport, system packet interface, et cetera) in a peer-to-peer configuration that substantially overcomes the bandwidth limitations, latency limitations and other limitations associated with the use of a conventional high-speed HyperTransport chain.

In general, a device configured as a tunnel-bridge hybrid has knowledge about which direction to send requests. For example, for device C to communicate with device A, device C knows that device A is downstream and is coupled to device B. As such, device C sends packets to device B for forwarding to device A as opposed to a traditional tunnel function, where device C would have to send packets for device A to device D, where device D would provide them back downstream after redefining itself as the source of the packets. To facilitate the more direct communications, each device maintains the address ranges, in range registers, for each link (or at least one of its links) and enforces ordering rules regardless of the Unit ID across its interfaces.

To facilitate the tunnel-hybrid functionality, since each device receives a unique Node ID, request packets are generated with the device's unique Node ID in the a Unit ID field of the packet. For packets that are forwarded upstream (or downstream), the Unit ID field and the source ID field of the request packets are preserved. As such, when the target device receives a request packet, the target device may accept the packet based on the address.

When the target device generates a response packet in response to a request packet(s), it uses the unique Node ID of the requesting device rather than the Node ID of the responding device. In addition, the responding device also preserves the Source Tag of the requesting device such that the response packet includes the Node ID and Source Tag of the requesting device. This enables the response packets to be accepted based on the Node ID rather than based on a bridge bit or direction of travel of the packet.

For a device to be configured as a tunnel-bridge hybrid, it export, at configuration of the system 20, a type 1 header (i.e., a bridge header in accordance with the HT specification) in addition to, or in place of, a type 0 header (i.e., a tunnel header in accordance with the HT specification). In response to the type 1 header, the host device programs the address range registers of the devices A-C and E-G regarding one or more links coupled to the devices. Once configured, the device utilizes the addresses in its address range registers to identify the direction (i.e., upstream link or downstream link) to send request packets and/or response packets to a particular device as described above.

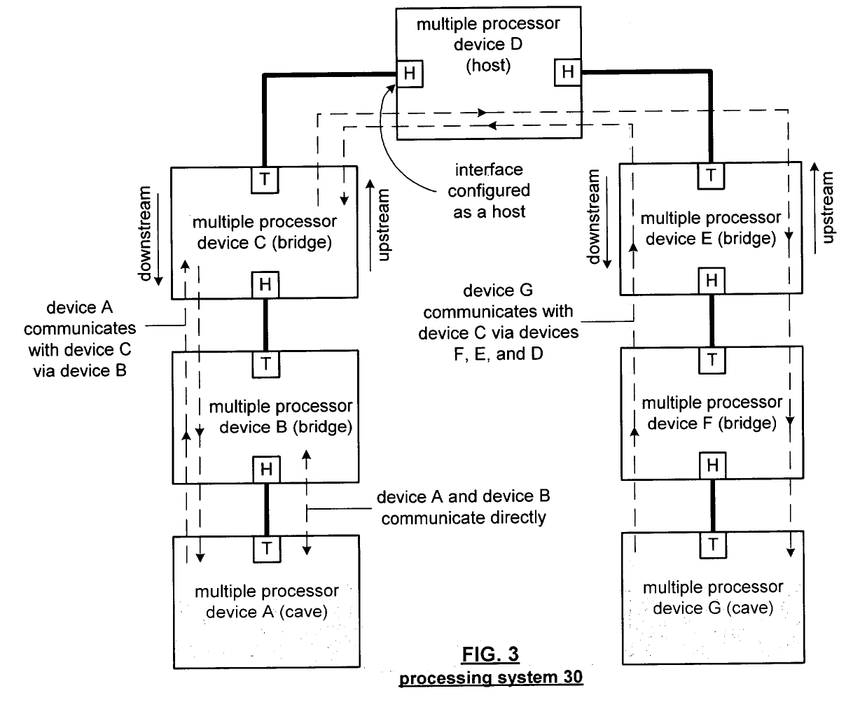

FIG. 3 is a schematic block diagram of processing system 30 that includes multiple processor devices A-G. In this embodiment, multiple processor device D is functioning as a host device for the system while the multiple processor devices B, C, E and F are configured to provide bridge functionality and devices A and G are configured to support a cave function. In this configuration, each of the devices may communicate directly (i.e., have peer-to-peer communication) with adjacent multiple processor devices via cascaded secondary chains. For example, device A may directly communicate With device B via a secondary chain therebetween, device B may communicate directly with device C via a secondary chain therebetween, device E may communicate directly with device F via a secondary chain therebetween, and device F may communicate directly with device G via a secondary chain therebetween. The primary chains in this example of a processing system exist between device D and device C and between device D and device E.

For communication between devices A and B, device B interprets packets received from device A to determine their destination. If device B is the destination, it processes it by providing it to the appropriate destination within, or associated with, device B. If a packet is not destined for device B, device B modifies the packet to identify itself as the source and forwards it to device C. Accordingly, if device A desires to communicate with device B, it does so directly since device B is providing a bridge function with respect to device A. However, for device A desires to communicate with device C, device B, as the host for the chain between devices A and B, modifies the packets to identify itself as the source of the packets. The modified packets are then routed to device C. To device C, the packets appear to be sourced from device B and not device A. For packets from device C to device A, device B modifies the packets to identify itself as the source of the packets and provides the modified packets to device A. In such a configuration, each device only knows that it is communicating with one device in the downstream direct and one device in the upstream direction. As such, peer-to-peer communication is supported directly between adjacent devices and is also supported indirectly (i.e., by modifying the packets to identify the host of the secondary chain as the source of the packets) between any devices in the system.

In any of the processing systems illustrated in FIGS. 1-3, the devices on one chain may communicate with devices on the other chain. An example of this is illustrated in FIG. 3 where device G may communicate with device C. As shown, packets from device G are propagated through devices D, E and F until they reach device C. Similarly, packets from device C are propagated through devices D, E and F until they reach device G. In the example of FIG. 3, the packets in the downstream direction and in the upstream direction are adjusted to modify the source of the packets. Accordingly, packets received from device G appear, to device C, to be originated by device D. Similarly, packets from device C appear, to device G, to be sourced by device F. As one of average skill in the art will appreciate, each device that is providing a host function or a bridge function maintains a table of communications for the chains it is the host to track the true source of the packets and the true destination of the packets.

FIG. 4 is a schematic block diagram of a multiple processor device 40 in accordance with the present invention. The multiple processor device 40 may be an integrated circuit or it may be constructed from discrete components. In either implementation, the multiple processor device 40 may be used as multiple processor device A-G in the processing systems illustrated in FIGS. 1-3.

The multiple processor device 40 includes a plurality of processing units 42-44, cache memory 46, memory controller 48, which interfaces with on and/or off-chip system memory, an internal bus 48, a node controller 50, a switching module 51, a packet manager 52, and a plurality of configurable packet based interfaces 54-56 (only two shown). The processing units 42-44, which may be two or more in numbers, may have a MIPS based architecture, to support floating point processing and branch prediction. In addition, each processing unit 42-44 may include a memory sub-system of an instruction cache and a data cache and may support separately, or in combination, one or more processing functions. With respect to the processing system of FIGS. 1-3, each processing unit 42-44 may be a destination within multiple processor device 40 and/or each processing function executed by the processing modules 42-44 may be a destination within the processor device 40.

The internal bus 48, which may be a 256 bit cache line wide split transaction cache coherent bus, couples the processing units 42-44, cache memory 46, memory controller 48, node controller 50 and packet manager 52 together. The cache memory 46 may function as an L2 cache for the processing units 42-44, node controller 50 and/or packet manager 52. With respect to the processing system of FIGS. 1-3, the cache memory 46 may be a destination within multiple processor device 40.

The memory controller 48 provides an interface to system memory, which, when the multiple processor device 40 is an integrated circuit, may be off-chip and/or on-chip. With respect to the processing system of FIGS. 1-3, the system memory may be a destination within the multiple processor device 40 and/or memory locations within the system memory may be individual destinations within the device 40. Accordingly, the system memory may include one or more destinations for the processing systems illustrated in FIGS. 1-3.

The node controller 50 functions as a bridge between the internal bus 48 and the configurable packet-based interfaces 54-56. Accordingly, accesses originated on either side of the node controller will be translated and sent on to the other. The node controller also supports the distributed shared memory model associated with the cache coherency non-uniform memory access (CC-NUMA) protocol.

The switching module 51 couples the plurality of configurable packet-based interfaces 54-56 to the node controller 50 and/or to the packet manager 52. The switching module 51 functions to direct data traffic, which may be in a generic format, between the node controller 50 and the configurable packet-based interfaces 54-56 and between the packet manager 52 and the configurable packet-based interfaces 54. The generic format may include 8 byte data words or 16 byte data words formatted in accordance with a proprietary protocol, in accordance with asynchronous transfer mode (ATM) cells, in accordance with internet protocol (IP) packets, in accordance with transmission control protocol/internet protocol (TCP/IP) packets, and/or in general, in accordance with any packet-switched protocol or circuit-switched protocol.

The packet manager 52 may be a direct memory access (DMA) engine that writes packets received from the switching module 51 into input queues of the system memory and reads packets from output queues of the system memory to the appropriate configurable packet-based interface 54-56. The packet manager 52 may include an input packet manager and an output packet manager each having its own DMA engine and associated cache memory. The cache memory may be arranged as first in first out (FIFO) buffers that respectively support the input queues and output queues.

The configurable packet-based interfaces 54-56 generally function to convert data from a high-speed communication protocol (e.g., HT, SPI, etc.) utilized between multiple processor devices 40 and the generic format of data within the multiple processor devices 40. Accordingly, the configurable packet-based interface 54 or 56 may convert received HT or SPI packets into the generic format packets or data words for processing within the multiple processor device 40. In addition, the configurable packet-based interfaces 54 and/or 56 may convert the generic formatted data received from the switching module 51 into HT packets or SPI packets. The particular conversion of packets to generic formatted data performed by the configurable packet-based interfaces 54 and 56 is based on configuration information 74, which, for example, indicates configuration for HT to generic format conversion or SPI to generic format conversion.

Each of the configurable packet-based interfaces 54-56 includes a transmit media access controller (Tx MAC) 58 or 68, a receiver (Rx) MAC 60 or 66, a transmitter input/output (I/O) module 62 or 72, and a receiver input/output (I/O) module 64 or 70. In general, the transmit MAC module 58 or 68 functions to convert outbound data of a plurality of virtual channels in the generic format to a stream of data in the specific high-speed communication protocol (e.g., HT, SPI, etc.) format. The transmit I/O module 62 or 72 generally functions to drive the high-speed formatted stream of data onto the physical link coupling the present multiple processor device 40 to another multiple processor device. The transmit I/O module 62 or 72 is further described, and incorporated herein by reference, in co-pending patent application entitled MULTI-FUNCTION INTERFACE AND APPLICATIONS THEREOF, having an attorney docket number of BP 2389, and having the same filing date and priority date as the present application. The receive MAC module 60 or 66 generally functions to convert the received stream of data from the specific high-speed communication protocol (e.g., HT, SPI, etc.) format into data from a plurality of virtual channels having the generic; format. The receive I/O module 64 or 70 generally functions to amplify and time align the high-speed formatted steam of data received via the physical link coupling the present multiple processor device 40 to another multiple processor device. The receive I/O module 64 or 70 is further described, and incorporated herein by reference, in co-pending patent application entitled RECEIVER MULTI-PROTOCOL INTERFACE AND APPLICATIONS THEREOF, having an attorney docket number of BP 2389.1, and having the same filing date and priority date as the present application.

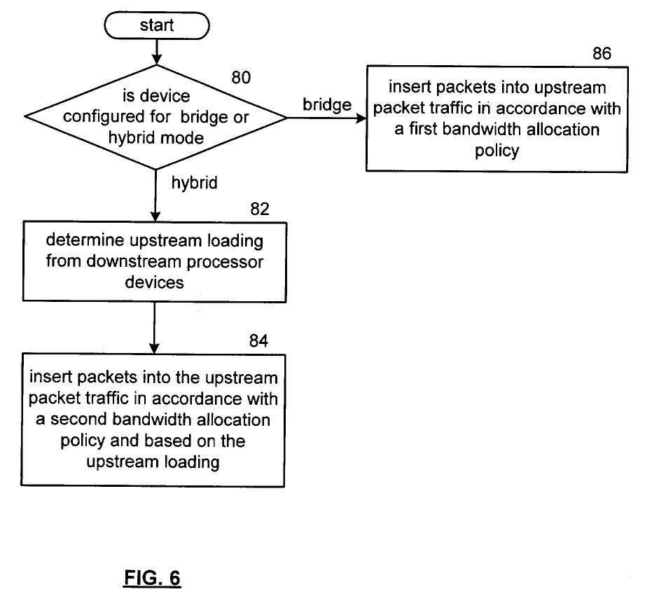

The transmit and/or receive MACs 58, 60, 66 and/or 68 may include, individually or in combination, a processing module and associated memory to perform its correspond functions. The processing module may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module implements one or more of its functions via a state machine, analog circuitry, digital circuitry, and/or logic circuitry, the memory storing the corresponding operational instructions is embedded with the circuitry comprising the state machine, analog circuitry, digital circuitry, and/or logic circuitry. The memory stores, and the processing module executes, operational instructions corresponding to the functionality performed by the transmitter MAC 58 or 68 as disclosed, and incorporated herein by reference, in co-pending patent application entitled TRANSMITTING DATA FROM A PLURALITY OF VIRTUAL CHANNELS VIA A MULTIPLE PROCESSOR DEVICE, having an attorney docket number of BP 2184.1 and having the same filing date and priority date as the present patent application and corresponding to the functionality performed by the receiver MAC module 60 or 66 as further described in FIGS. 6-10.

In operation, the configurable packet-based interfaces 54-56 provide the means for communicating with other multiple processor devices 40 in a processing system such as the ones illustrated in FIGS. 1, 2 or 3. The communication between multiple processor devices 40 via the configurable packet-based interfaces 54 and 56 is formatted in accordance with a particular high-speed communication protocol (e.g., HyperTransport (HT) or system packet interface (SPI)). The configurable packet-based interfaces 54-56 may be configured to support, at a given time, one or more of the particular high-speed communication protocols. In addition, the configurable packet-based interfaces 54-56 may be configured to support the multiple processor device 40 in providing a tunnel function, a bridge function, or a tunnel-bridge hybrid function.

When the multiple processor device 40 is configured to function as a tunnel-hybrid node, the configurable packet-based interface 54 or 56 receives the high-speed communication protocol formatted stream of data and separates, via the MAC module 60 or 68, the stream of incoming data into generic formatted data associated with one or more of a plurality a particular virtual channels. The particular virtual channel may be associated with a local module of the multiple processor device 40 (e.g., one or more of the processing units 42-44, the cache memory 46 and/or memory controller 48) and, accordingly, corresponds to a destination of the multiple processor device 40 or the particular virtual channel may be for forwarding packets to the another multiple processor device.

The interface 54 or 56 provides the generically formatted data words, which may comprise a packet, or portion thereof, to the switching module 51, which routes the generically formatted data words to the packet manager 52 and/or to node controller 50. The node controller 50, the packet manager 52 and/or one or more processing units 42-44 interprets the generically formatted data words to determine a destination therefor. If the destination is local to multiple processor device 40 (i.e., the data is for one of processing units 42-44, cache memory 46 or memory controller 48), the node controller 50 and/or packet manager 52 provides the data, in a packet format, to the appropriate destination. If the data is not addressing a local destination, the packet manager 52, node controller 50 and/or processing unit 42-44 causes the switching module 51 to provide the packet to one of the other configurable packet-based interfaces 54 or 56 for forwarding to another multiple processor device in the processing system. For example, if the data were received via configuration packet-based interface 54, the switching module 51 would provide the outgoing data to configurable packet-based interface 56. In addition, the switching module 51 provides outgoing packets generated by the local modules of processing module device 40 to one or more of the configurable packet-based interfaces 54-56.

The configurable packet-based interface 54 or 56 receives the generic formatted data via the transmitter MAC module 58 or 68. The transmitter MAC module 58, or 68 converts the generic formatted data from a plurality of virtual channels into a single stream of data. The transmitter input/output module 62 or 72 drives the stream of data on to the physical link coupling the present multiple processor device to another.

When the multiple processor device 40 is configured to function as a tunnel node, the data received by the configurable packet-based interfaces 54 from a downstream node is routed to the switching module 51 and then subsequently routed to another one of the configurable packet-based interfaces for transmission upstream without interpretation. For downstream transmissions, the data is interpreted to determine whether the destination of the data is local. If not, the data is routed downstream via one of the configurable packet-based interfaces 54 or 56.

When the multiple processor device 40 is configured as a bridge node, upstream packets that are received via a configurable packet-based interface 54 are modified via the interface 54, interface 56, the packet manager 52, the node controller 50, and/or processing units 42-44 to identify the current multiple processor device 40 as the source of the data. Having modified the source, the switching module 51 provides the modified data to one of the configurable packet-based interfaces for transmission upstream. For downstream transmissions, the multiple processor device 40 interprets the, data to determine whether it contains the destination for the data. If so, the data is routed to the appropriate destination. If not, the multiple processor device 40 forwards the packet via one of the configurable packet-based interfaces 54 or 56 to a downstream device.

To determine the destination of the data, the node controller 50, the packet manager 52 and/or one of the processing units 42 or 44 interprets header information of the data to identify the destination (i.e., determines whether the target address is local to the device). In addition, a set of ordering rules of the received data is applied when processing the data, where processing includes forwarding the data, in packets, to the appropriate local destination or forwarding it onto another device. The ordering rules include the HT specification ordering rules and rules regarding non-posted commands being issued in order of reception. The rules further include that the interfaces are aware of whether they are configured to support a tunnel, bridge, or tunnel-bridge hybrid node. With such awareness, for every ordered pair of transactions, the receiver portion of the interface will not make a new transaction of an ordered pair visible to the switching module until the old transaction of an ordered pair has been sent to the switching module. The node controller, in addition to adhering to the HT specified ordering rules, treats all HT transactions as being part of the same input/output stream, regardless of which interface the transactions was received from. Accordingly, by applying the appropriate ordering rules, the routing to and from the appropriate destinations either locally or remotely is accurately achieved.

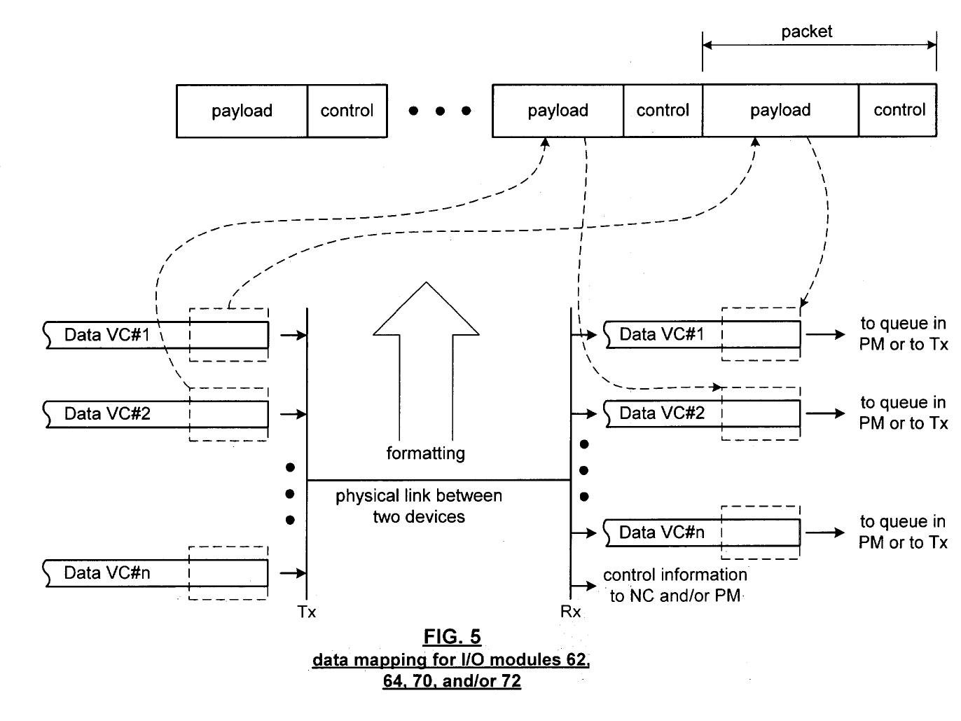

FIG. 5 is a graphical representation of the functionality performed by the node controller 50, the switching module 51, the packet manager 52 and/or the configurable packet-based interfaces 54 and 56. In this illustration, data is transmitted over a physical link between two devices in accordance with a particular high-speed communication protocol (e.g., HT, SPI-4, etc.). Accordingly, the physical link supports a protocol that includes a plurality of packets. Each packet includes a data payload and a control section. The control section may include header information regarding the payload, control data for processing the corresponding payload of a current packet, previous packet(s) or subsequent packet(s), and/or control data for system administration functions.

Within a multiple processor device, a plurality of virtual channels may be established. A virtual channel may correspond to a particular physical entity, such as processing units 42-44, cache memory 46 and/or memory controller 48, and/or to a logical entity such as a particular algorithm being executed by one or more of the processing modules 42-44, particular memory locations within cache memory 46 and/or particular memory locations within system memory accessible via the memory controller 48. In addition, one or more virtual channels may correspond to data packets received from downstream or upstream nodes that require forwarding. Accordingly, each multiple processor device supports a plurality of virtual channels. The data of the virtual channels, which is illustrated as data virtual channel number 1 (VC#1), virtual channel number 2 (VC#2) through virtual channel number N (VC#n) may have a generic format. The generic format may be 8 byte data words, 16 byte data words that correspond to a proprietary protocol, ATM cells, IP packets, TCP/IP packets, other packet switched protocols and/or circuit switched protocols.

As illustrated, a plurality of virtual channels is sharing the physical link between the two devices. The multiple processor device 40, via one or more of the processing units 42-44, node controller 50, the interfaces 54-56, and/or packet manager 52 manages the allocation of the physical link among the plurality of virtual channels. As shown, the payload of a particular packet may be loaded with one or more segments from one or more virtual channels. In this illustration, the 1^{st} packet includes a segment, or fragment, of virtual channel number 1. The data payload of the next packet receives a segment, or fragment, of virtual channel number 2. The allocation of the bandwidth of the physical,; link to the plurality of virtual channels may be done in a round-robin fashion, a weighted round-robin fashion or some other application of fairness. The data transmitted across the physical link may be in a serial format and at extremely high data rates (e.g., 3.125, gigabits-per-second or greater), in a parallel format, or a combination thereof (e.g., 4 lines of 3.125 Gbps serial data).

At the receiving device, the stream of data is received and then separated into the corresponding virtual channels via the configurable packet-based interface, the switching module 51, the node controller 50, the interfaces 54-56, and/or packet manager 52. The recaptured virtual channel data is either provided to an input queue for a local destination or provided to an output queue for forwarding via one of the configurable packet-based interfaces to another device. Accordingly, each of the devices in a processing system as illustrated in FIGS. 1-3 may utilize a high speed serial interface, a parallel interface, or a plurality of high speed serial interfaces, to transceive data from a plurality of virtual channels utilizing one or more communication protocols and be configured in one or more configurations while substantially overcoming the bandwidth limitations, latency limitations, limited concurrency (i.e., renaming of packets) and other limitations associated with the use of a high speed HyperTransport chain. Configuring the multiple processor devices for application in the multiple configurations of processing systems is described in greater detail and incorporated herein by reference in co-pending patent application entitled MULTIPLE PROCESSOR INTEGRATED CIRCUIT HAVING CONFIGURABLE PACKET-BASED INTERFACES, having an attorney docket number of BP 2186, and having the same filing date and priority date as the present patent application.

FIG. 6 illustrates a logic diagram of a method for each processing device within a processing system, as illustrated in FIGS. 1, 2 or 3, to provide bandwidth allocation fairness. The process begins at Step 80 where the processing device determines whether it is configured in a bridge mode or a tunnel-bridge hybrid mode. When the device is configured in the bridge mode, the process proceeds to Step 86, where the processor device inserts packets into upstream packet traffic in accordance with a 1^{st} bandwidth allocation policy. Accordingly, packets received from downstream nodes make-up the upstream packet traffic. In one instance of the 1^{st} bandwidth allocation policy, the processing module inserts packets into the upstream packet traffic without regard to the upstream loading from the downstream processing devices. In such a mode, the processing device renames downstream packets to identify itself as the source and transmits the renamed packets along with packets generated by the device. Alternatively, the 1^{st} bandwidth allocation policy may cause the processing module to utilize the unit identification codes of downstream processor devices for packets from the downstream processor devices in the upstream packet traffic. In other words, the processor device does not re-identify the source of downstream packets, thus maintaining the identity of the true source of the packets. While maintaining the identity of the true source of the packets, the processing module inserts its packets into the upstream packet traffic based on the upstream loading produced by downstream devices.

If the processor device determines that it is configured in a hybrid mode, the process proceeds to Step 82 where the processor device determines upstream loading from downstream processor devices. For instance, for a predetermined period of time and for each of the downstream processor devices, the processor device determines a number of upstream packets included in the upstream packet traffic. The processor device then determines a largest number of upstream packets from the number of upstream packets for each of the downstream processor devices. For example, if there are two downstream processor devices, the 1^{st} has inserted three packets over the predetermined period of time and the other has inserted four packets, the larger number is four. Based on this larger number, the current processor device may insert up to the largest number of upstream packets into the stream of packets. For the example provided, the processor device may insert up to four packets for the given period of time.

The determination of the upstream loading may also include receiving the plurality of packets from downstream processors and determining which of these packets relate to peer-to-peer communications between the current processor device and at least one of the downstream processor devices. The packets that correspond to peer-to-peer communications are excluded from the number of packets within the upstream packet traffic. For example, if there are two downstream processors, the 1^{st} transmitting three packets during a given period of time (e.g., a few microseconds to hundreds of milliseconds or greater) and the 2^{nd} providing four packets during the given period of time, where two of the four packets from the 2^{nd} downstream device are for peer-to-peer communication with the current device, those two packets are not included in the determination for the largest number. As such, in this example, three packets are the largest number, which is then used to determine the number of upstream packets inserted by the current processing device.

The process then proceeds to Step 84 where the processor device inserts packets in the upstream packet traffic in accordance with the 2^{nd} bandwidth allocation policy and based on the upstream loading.

One embodiment of a fairness algorithm includes two parts: local maximum allowable insertion rate and achieving that rate in a smooth, non-bursty, manner. To calculate the local maximum allowable insertion rate, the device maintains: (1) a 3-bit counter for each node downstream. Each counter is incremented as a packet is forwarded from the downstream node; (2) an 8-bit counter that is incremented when any packet is forwarded. When any one of the 3-bit counter wraps around, the current value of the 8-bit counter is stored in a denominator register, all of the 3-bit counters are cleared, the 8-bit counter is set to 1, and the count begins once again.

To achieve the non-bursty insertion, the denominator is divided by 8 and stored in a window register such that one local packet is inserted for every denominator/8 packets that are forwarded. The value stored in the window register is updated based on the equation

Window 32 (Denominator+LFSR [2:0])>>3.

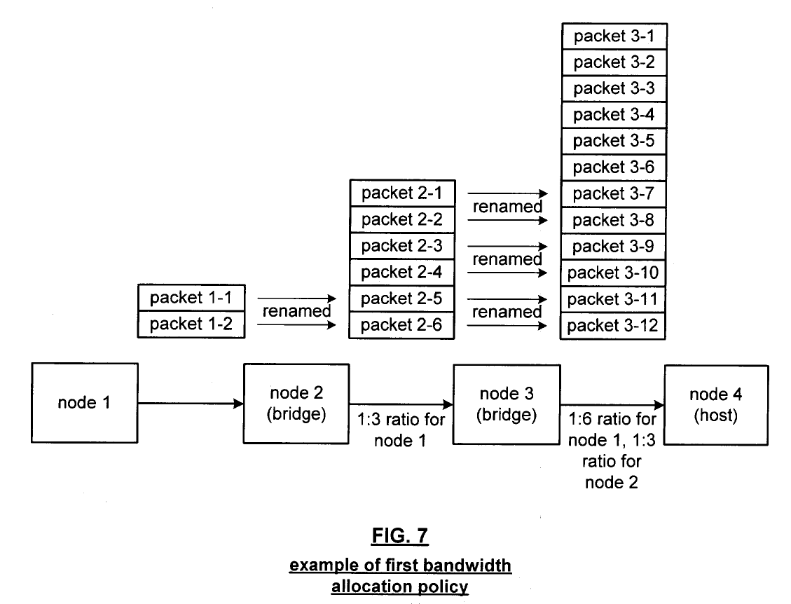

FIG. 7 is a graphical representation of an example of the 1^{st} bandwidth allocation policy in accordance with the present invention. As shown, four processor devices, labeled node 1, 2, 3 and 4, are configured where node 4 functions as the host, node 3 as a bridge, node 2 as a bridge and node 1 as the end point. In this example, during a given period of time, node 1 transmits two packets 1-1 and 1-2, where the 1^{st} number indicates the node identity and the 2^{nd} number indicates the packet number, to node 2. Node 2, applying the 1^{st} bandwidth allocation policy, renames the, packets received from node 1 and inserts its own packets. In this example, node 1, during the given period of time has four packets to transmit, 2-1, 2-2, 2-3 and 2-4. The 2^{nd} node renames packets 1-1 and packets 1-2 to packets 2-4 and 2-5. Accordingly, for this example, the link between nodes 2 and 3 has a 1-to-3 ratio for the packets transmitted by node 1 to the packets transmitted by node 2.

Node 3, during the given period of time has six packets to transmit, 3-1 through 3-6. In addition, node 3 renames packets 2-1 through 2-6 to packets 3-7 through 3-12. Accordingly, in this example the link between node 3 and node 4 has a 1-to-6 ratio of packets being transmitted to node 4 by node 1, a 1-to-3 ratio of packets transmitted from node 2 to node 4 and a 1-to-2 ratio for packets transmitted by node 3. Thus, the 1^{st} bandwidth allocation policy allows for imbalanced packet loading on links coupling the devices together.

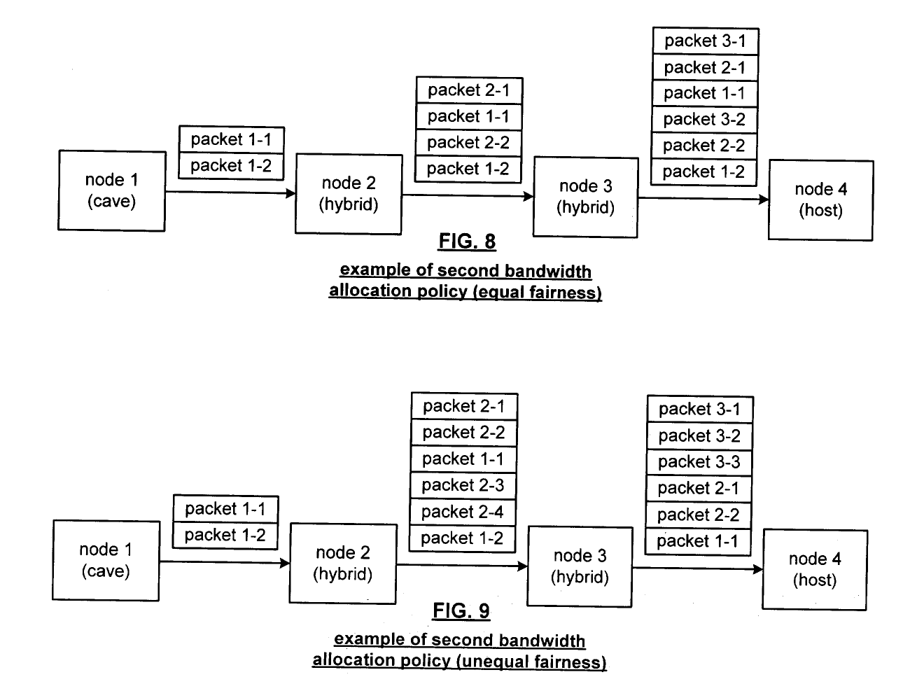

FIG. 8 is a graphical example of the 2^{nd} bandwidth allocation policy that employs equal fairness, i.e., the bandwidth of the link is equally divided among the downstream nodes. In this example, four devices are configured in a chain as node 1, 2, 3 and 4. Node 4 functions as the host for the chain. In this example, during a given period of time, node 1 transmits two packets to node 2. Node 2, while configured as a tunnel or as a hybrid node, performs the 2^{nd} bandwidth allocation policy and as such does not rename the source of packets 1-1 and 1-2. Accordingly, the link between nodes 2 and 3 may be setup to provide a 1-to-1 ratio of packets transmitted between node 2 and node 3 for node 1 and node 2.

Node 3, which is configured in the tunnel mode or hybrid mode, receives the plurality of packets from node 2 and does not rename the source of these packets. Accordingly, the packets generated by node 3 and the packets received from downstream nodes 1 and 2 are provided to node 4 in a desired ratio. The desired ratio may be 1-to-1 for each of the nodes, (e.g., for this example for every three packets transmitted between node 3 and node 4 one is for node 1, another is for node 2 and the last is for node 3).

FIG. 9 is a graphical example of the 2^{nd} bandwidth allocation policy that employs unequal fairness, i.e., the bandwidth of the link is unequally divided among the downstream nodes. In this example, four devices are configured in a chain as node 1, 2, 3 and 4. Node 4 functions as the host for the chain. In this example, during a given period of time, node 1 transmits two packets to node 2. Node 2, while configured as a tunnel or as a hybrid node, performs the 2^{nd} bandwidth allocation policy and as such does not rename the source of packets 1-1 and 1-2. Accordingly, the link between nodes 2 and 3 may be setup to provide a 2-to-1 ratio (or any other desired ratio) of packets transmitted between node 2 and node 3 for node 1 and node 2. As shown, for every one packet sourced by node 1 transmitted on the link between nodes 2 and 3, two packets sourced by node 2 are transmitted on the link between nodes 2 and 3.

Node 3, which is configured in the tunnel mode or hybrid mode, receives the plurality of packets from node 2 and does not rename the source of these packets. Accordingly, the packets generated by node 3 and the packets received from downstream nodes 1 and 2 are provided to node 4 in a desired ratio. The desired ratio may be 3-to-2-to-1 (or any other desired ratio) for each of the nodes, (e.g., for this example for every six packets transmitted between node 3 and node 4 one is from node 1, two are from node 2 and three are from node 3).

The preceding discussion has presented a method and apparatus for providing programmable bandwidth allocation fairness within a processing system of a plurality of processor devices. By providing programmable bandwidth allocation fairness, the processing system may be configured in a variety of ways and yet still overcome bandwidth limitations, latency limitations and other limitations associated with the use of a high speed HyperTransport chain. As one of average skill in the art will appreciate, other embodiments may be derived from the teaching of the present invention, without deviating from the scope of the claims.

What is claimed is:

1. A method for providing bandwidth allocation fairness within a processing system that includes a plurality of processor devices, the method comprises:
for a processor device of the plurality of processor devices:
inserting, by the processor device, packets into upstream packet traffic in accordance with a first bandwidth allocation policy when the processor device is configured to transceive packets in a bridge mode;
determining upstream loading from downstream processor devices of the plurality of processor devices when the processor device is configured to transceive packets in a tunnel-bridge hybrid mode; and
inserting, by the processor device, the packets into the upstream packet traffic in accordance with a second bandwidth allocation policy and based on the upstream loading when the processor device is configured to transceive packets in a tunnel-bridge hybrid mode.

2. The method of claim 1, wherein the inserting packets into the upstream packet traffic in accordance with the first bandwidth allocation policy further comprises:
inserting the packets without regard to the upstream loading from the downstream processor devices.

3. The method of claim 1, wherein the inserting the packets into the upstream packet traffic in accordance with the first bandwidth allocation policy further comprises:
utilizing unit identification codes of the downstream processor devices for packets from the downstream processor devices in the upstream packet traffic;
inserting the packets into the upstream packet traffic based on the upstream loading.

4. The method of claim 1, wherein the determining the upstream loading further comprises:
for a predetermined period of time and for each of the downstream processor devices:
determining a number of upstream packets included in the upstream packet traffic; and
determining a largest number of upstream packets from the number of upstream packets for each of the downstream processor devices.

5. The method of claim 4, wherein the inserting the packets into the upstream packet traffic in accordance with a second bandwidth allocation policy further comprises:
inserting, during the predetermined period of time, a number of packets up to the largest number of upstream packets.

6. The method of claim 4, wherein the determining the number of upstream packets further comprises:
receiving a plurality of packets from the downstream processor devices;
determining which packets of the plurality of packets related to peer-to-peer communication between the processor device and one of the downstream processor devices; and
excluding the packets related to the peer-to-peer communication from the number of upstream packets.

7. An apparatus for providing bandwidth allocation fairness within a processing system that includes a plurality of processor devices, the apparatus comprises:
processing module; and
memory operably coupled to the processing module, wherein the memory includes operational instructions that cause the processing module to:
for a processor device of the plurality of processor devices:
insert packets into upstream packet traffic in accordance with a first bandwidth allocation policy when the processor device is configured to transceive packets in a bridge mode;
determine upstream loading from downstream processor devices of a plurality of processor devices when the processor device is configured to transceive packets in a tunnel-bridge hybrid mode; and
insert the packets into the upstream packet traffic in accordance with a second bandwidth allocation policy and based on the upstream loading when the processor device is configured to transceive packets in a tunnel-bridge hybrid mode.

8. The apparatus of claim 7, wherein the memory further comprises operational instructions that cause the processing module to insert packets into the upstream packet traffic in accordance with the first bandwidth allocation policy by:
inserting the packets without regard to the upstream loading from the downstream processor devices.

9. The apparatus of claim 7, wherein the memory further comprises operational instructions that cause the processing module to insert the packets into the upstream packet traffic in accordance with the first bandwidth allocation policy by:
utilizing unit identification codes of the downstream processor devices for packets from the downstream processor devices in the upstream packet traffic;
inserting the packets into the upstream packet traffic based on the upstream loading.

10. The apparatus of claim 7, wherein the memory further comprises operational instructions that cause the processing module to determine the upstream loading by:
for a predetermined period of time and for each of the downstream processor devices:
determining a number of upstream packets included in the upstream packet traffic; and
determining a largest number of upstream packets from the number of upstream packets for each of the downstream processor devices.

11. The apparatus of claim 10, wherein the memory further comprises operational instructions that cause the processing module to insert the packets into the upstream packet traffic in accordance with a second bandwidth allocation policy by:
inserting, during the predetermined period of time, a number of packets up to the largest number of upstream packets.

12. The apparatus of claim 10, wherein the memory further comprises operational instructions that cause the processing module to determine the number of upstream packets further comprises:
receiving a plurality of packets from the downstream processor devices;
determining which packets of the plurality of packets related to peer-to-peer communication between the processor device and one of the downstream processor devices; and
excluding the packets related to the peer-to-peer communication from the number of upstream packets.

13. A multiple processor integrated circuit comprises:
a plurality of processing units;
cache memory;
memory controller operably coupled to system memory;
internal bus operably coupled to the plurality of processing units, the cache memory and the memory controller;
packet manager operably coupled to the internal bus;
node controller operably coupled to the internal bus;
first configurable packet-based interface;
second configurable packet-based interface; and
switching module operably coupled to the packet manager, the node controller, the first configurable packet-based interface, and the second configurable packet-based interface, wherein at least one of the packet manager and the node controller function to:
insert packets into upstream packet traffic in accordance with a first bandwidth allocation policy when the processor device is configured to transceive packets in a bridge mode;
determine upstream loading from downstream processor devices of a plurality of processor devices when the processor device is configured to transceive packets in a tunnel-bridge hybrid mode; and
insert the packets into the upstream packet traffic in accordance with a second bandwidth allocation policy and based on the upstream loading when the processor device is configured to transceive packets in a tunnel-bridge hybrid mode.

14. The multiple processor integrated circuit of claim 13, wherein at least one of the packet manager and the node controller function to insert packets into the upstream packet traffic in accordance with the first bandwidth allocation policy by:
inserting the packets without regard to the upstream loading from the downstream processor devices.

15. The multiple processor integrated circuit of claim 13, wherein at least one of the packet manager and the node controller function to insert the packets into the upstream packet traffic in accordance with the first bandwidth allocation policy by:
utilizing unit identification codes of the downstream processor devices for packets from the downstream processor devices in the upstream packet traffic;
inserting the packets into the upstream packet traffic based on the upstream loading.

16. The multiple processor integrated circuit of claim 13, wherein at least one of the packet manager and the node controller function to determine the upstream loading by:
for a predetermined period of time and for each of the downstream processor devices:
determining a number of upstream packets included in the upstream packet traffic; and
determining a largest number of upstream packets from the number of upstream packets for each of the downstream processor devices.

17. The multiple processor integrated circuit of claim 16, wherein at least one of the packet manager and the node controller function to insert the packets into the upstream packet traffic in accordance with a second bandwidth allocation policy by:
inserting, during the predetermined period of time, a number of packets up to the largest number of upstream packets.

18. The multiple processor integrated circuit of claim 16, wherein at least one of the packet manager and the node controller function to determine the number of upstream packets by:
receiving a plurality of packets from the downstream processor devices;
determining which packets of the plurality of packets related to peer-to-peer communication between the processor device and one of the downstream processor devices; and
excluding the packets related to the peer-to-peer communication from the number of upstream packets.
